(19) United States
(12) Patent Application Publication
(10) Pub. No.: US 2025/0175802 A1
(43) Pub. Date: May 29, 2025

(54) NATIVE DIALER VERIFICATION FOR A MOBILE COMPUTING DEVICE

(71) Applicant: Microsoft Technology Licensing, LLC, Redmond, WA (US)

(72) Inventors: Amer Aref Hassan, Kirkland, WA (US); Shaun Paul Dunning, San Clemente, CA (US); Michele Kinsey, Redmond, WA (US); Tonu Vanatalu, Tallinn (EE)

(21) Appl. No.: 18/522,171

(22) Filed: Nov. 28, 2023

(51) Int. Cl. H04W 12/128; H04W 12/126

(52) U.S. Cl. CPC H04W 12/128; H04W 12/126

(57) ABSTRACT

A method for detecting fraudulent SIM swapping on a mobile device is provided. A server of a communications service receives a call request from a mobile device and obtains an identifier unique to the device. The obtained identifier is compared to a stored identifier and if different, the call request is held in a temporary state, pending authentication. To authenticate, a message with authentication instructions is sent via a messaging service of the communications service. The message provides instructions for the user to transmit a specific code from the mobile device's native messaging application to a server. Upon receiving the code, the device is authenticated before further call processing. Alternatively, a client application initiates a synthetic call which is then handed off to the native dialer application. If the handoff fails due to the native dialer's lack of mobile network connectivity, the device is then suspected of being compromised, such that additional authentication is required. The server thus provides enhanced security by leveraging the native dialer and messaging application.

### TECHNICAL FIELD

The present application relates to the technical field of data security in online communications, specifically those conducted over mobile networks. More specifically, the present application involves a technique for detecting situations in which a Subscriber Identity Module (SIM) associated with a mobile computing device may have been fraudulently swapped or transferred to another device without proper authorization, a malicious act often referred to as SIM “jacking” or SIM “swapping”.

### BACKGROUND

A SIM card is a small, removable card that is critical for operating and identifying a mobile device on a cellular network, often referred to as a mobile network. The SIM card contains the International Mobile Subscriber Identity (IMSI), which uniquely identifies a user (e.g., a subscriber) on a mobile network. The SIM card also stores the Mobile Station International Subscriber Directory Number (MSISDN), more commonly known as a telephone number. It also stores authentication keys for securing communications, and other configuration data like the Service Provider Name (SPN) for a mobile network operator, also referred to as a mobile network provider.

An eSIM serves the same overall functions as a traditional physical SIM card, but in an integrated digital form. The eSIM is typically soldered directly onto a device's motherboard rather than being a removable card. Like a SIM card, the eSIM stores the IMSI and authentication keys needed to connect to a mobile network. However, the eSIM approach saves physical space and eliminates the need for a SIM card slot on the mobile device. Additionally, eSIMs can be reprogrammed remotely to change carriers or plans without swapping physical SIM cards. This makes switching between mobile network providers easier, especially for devices requiring frequent network changes.

Both SIM cards and eSIMs play essential security roles within mobile devices. They contain unique identifiers that authenticate the device to the mobile network, preventing unauthorized access. The SIM/eSIM also store encryption keys for securing communications over the mobile network. Additionally, they associate the device with the user's phone number, which is necessary for making and receiving calls and messages. If a malicious actor compromises the SIM/eSIM, they could impersonate the user's phone number and gain access to user accounts and user data secured by SMS-based two-factor authentication. Therefore, the SIM/eSIM are critical for establishing trusted device identity and protecting the mobile device and linked accounts from fraudulent access.

### BRIEF DESCRIPTION OF THE DRAWINGS

Embodiments of the present invention are illustrated by way of example and not limitation in the figures of the accompanying drawings, in which:

FIG. 1 is a diagram illustrating an example of how a subscriber to a mobile network may lose mobile network connectivity, subsequent to having a SIM or eSIM hijacked by a malicious actor.

FIG. 2 is a diagram illustrating a network environment, consistent with which an embodiment of the invention may be deployed, wherein the network environment includes a unified communications service that has been integrated to operate seamlessly with a mobile network.

FIGS. 3A and 3B are user interface diagrams illustrating two examples of an authentication request or authentication message that may be communicated to a subscriber of a unified communications service, for purposes of authenticating a native dialer application on a mobile computing device, consistent with some embodiments.

FIG. 4 illustrates an alternative technique for authenticating a mobile computing device, and specifically, the native dialing application of the device. In this technique, the mobile device includes a native dialer, and a UC client application.

FIG. 5 is a block diagram illustrating a software architecture, which can be installed on any of a variety of computing devices to perform methods consistent with those described herein.

FIG. 6 is a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are methods and systems for authenticating a mobile computing device associated with a subscriber to a unified communications service, for purposes of detecting and preventing attacks resulting from SIM jacking or SIM swapping. In the following description, numerous specific details are set forth regarding exemplary embodiments of the present invention in order to provide a thorough understanding of the various aspects of different embodiments. However, one skilled in the art will understand that the present invention may be practiced without utilizing all of the specific details presented in this description. Some well-known structures and functions may not be shown or described to avoid obscuring the disclosure.

SIM jacking and SIM swapping occur when a malicious actor illegally ports a mobile computing device phone number of a subscriber to a mobile network operator to a SIM card or eSIM under their control. This unauthorized transfer allows the malicious actor to intercept calls and messages (e.g., text message and SMS messages) intended for the victim's device. The malicious actor can also impersonate the victim by making outbound calls, receiving inbound calls, and sending and receiving messages from a device using the hijacked phone number. By posing as the victim, the malicious actor can interact with customer service agents or spread disinformation. Furthermore, authentication codes, including one-time passcodes sent via SMS, can be exploited by the malicious actor to bypass multi-factor authentication and access the victim's online accounts, enabling identity theft and financial fraud. Through SIM jacking and SIM swapping, the malicious actor can fully impersonate the victim's phone identity.

The consequences of SIM jacking and swapping attacks can be severe. By gaining control of the victim's phone number, the malicious actor can potentially reset account passwords and bypass two-factor authentication secured by SMS passcodes. This grants the malicious actor access to the victim's online accounts, finances, and personal data. Beyond enabling fraud and identity theft, SIM swapping also jeopardizes the confidentiality of the victim's phone communications. Accordingly, SIM jacking and swapping represent serious threats to individuals' privacy, accounts, and assets accessed through mobile computing devices.

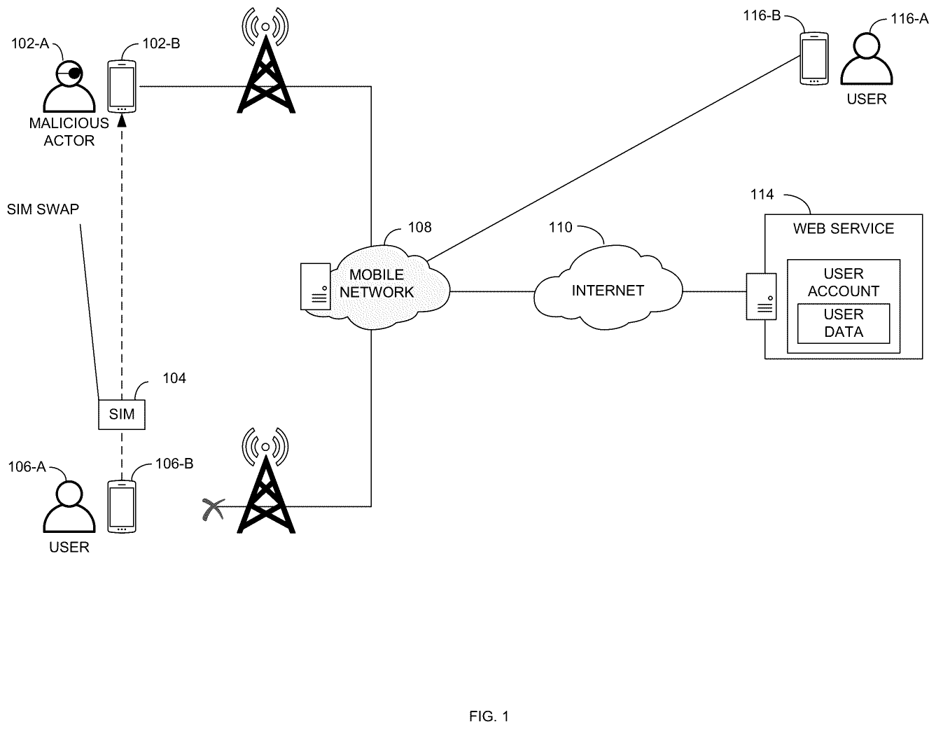

FIG. 1 is a diagram illustrating an example of how a subscriber 106-A to a mobile network 108 may lose mobile network connectivity, subsequent to having a SIM or eSIM hijacked by a malicious actor 102-A. As shown in FIG. 1, a malicious actor 102-A has swapped the SIM 104 of a user 106-A and is now impersonating the user's phone number on his or her mobile device 102-B. There are numerous ways that a malicious actor may hijack, swap or steal the SIM (including an eSIM) of another user, such as physically stealing the SIM card, utilizing social engineering to convince a mobile network operator to reprogram the victim's eSIM, or intercepting a QR code or unique identifier for activating an eSIM.

Meanwhile, the user's mobile device 106-B no longer connects to the mobile network 108, and all communications directed over the mobile network 108 to the user's phone number are now routed to the malicious actor's mobile device 102-B. The malicious actor 102-A has effectively hijacked the phone identity of the user 106-A. With control of the user's phone number, the malicious actor 102-A can now intercept any calls and messages intended for the user's mobile device 106-B. For example, if another user 116-A places a telephone call with his or her mobile device 116-B, using the telephone number of the subscriber-user 106-A that is associated with the SIM 104, the mobile network 108 will route and connect the call to the mobile device 102-B of the malicious actor 102-A. Similarly, when the user 106-A attempts to login to a web service 114 to access his or her account and user data (e.g., using a WiFi® connection to the Internet 110, or via another computing device), the web service 114 may send an SMS message with an authentication request to the telephone number of the user 106-A, which means that the SMS message will be received by the malicious actor 102-A who has hijacked the SIM 104 of the user 106-A.

As other web services, like social media accounts, email services, and cryptocurrency exchanges often rely on SMS passcodes for two-factor authentication, having a SIM or eSIM hijacked can lead to serious problems. By hijacking the user's SIM, the malicious actor 102-A (now an attacker) can circumvent security measures and gain entry to the user's many online accounts. The malicious actor 102-A may proceed to steal funds, data, and personal information from the victim. This illustrates the gravity of the SIM swapping threat.

The threat posed by SIM swapping attacks stems from technical vulnerabilities in the authentication protocols used by mobile networks, online services, and mobile computing devices. Specifically, the ability for a malicious actor to intercept messages, calls, and authentication challenges intended for a recipient associated with a particular SIM depends on the technical mechanisms mobile networks use to route communications to devices based on SIM information. Accordingly, the authentication protocols used by online services to verify users with SMS codes suffer from technical shortcomings that fail to prevent exploitation by SIM swappers. The technical components of these systems, including SIM card technology for device identification, mobile network communication protocols, and online service authentication schemes require improvements to fix the technical gaps that hackers and malicious actors currently exploit with SIM swapping fraud.

Embodiments of the present invention provide a technical solution to the technical problems described above. Consistent with some embodiments, a communications service, such as one that provides unified communications, maintains data records for the subscribers of the service. Specifically, for each subscriber to the communications service, at least one data record is maintained to map a subscriber identifier, representing the subscriber to the communications service, to a device identifier, representing a mobile computing device (e.g., a mobile phone) with which the subscriber uses a SIM or eSIM to access a mobile network with which the communications service is integrated. When a server computer associated with the communications service receives a call request for a subscriber to the communications service, the server computer verifies that the device identifier of the mobile computing device matches the subscriber identifier for the device included in the data record for the subscriber.

By way of example, John Doe is a subscriber to the communications service and has a mobile phone with a unique device identifier of “A1B2C3D4E5”. In the communications service's data records, John Doe's subscriber account containing his phone number, (123) 456-7890 is mapped to device ID “A1B2C3D4E5”. When John Does makes, or receives, a call request that references his phone number, the server computer that is processing the call request will check to ensure that the mobile device that is currently using John Doe's phone number (e.g., (123) 456-7890), as stored on the SIM or eSIM, has a device identifier that matches the device identifier that is in the data record, thereby confirming John Doe is using his expected phone.

Accordingly, when a server computer of the communications service receives a call request, and the call request references the phone number of a known subscriber to the communications service, the communications service obtains a unique identifier for the device associated with the phone number. This unique device identifier may be obtained in one of several different ways, depending upon various factors. One method is to include the device identifier as a data field in the call request message itself. The server simply parses the message to extract the device identifier. Another way is using call signaling protocols like SIP. In this case, the server computer sends a SIP request to the device asking for its identifier, and the device returns the identifier in the SIP response. Additionally, if the user has a client communications application for the communications service installed, the application can directly transmit the device identifier to the server computer through an Internet connection. The application may persistently execute in the background to enable periodic identifier checks. As such, there are various options for the server computer to securely obtain the device identifier for verification.

Continuing with the example, when the server computer receives a call request referencing John Doe's phone number (123) 456-7890, the server computer fetches the device identifier “A1B2C3D4E5” stored for that number in John's subscriber account. The server then checks whether the device identifier in the call request matches “A1B2C3D4E5”. Alternatively, if the device identifier is not included as part of the call request, the server will query the device using the phone number, for example, using SIP signaling or some other network communications protocol, to obtain the device identifier. If the identifiers match, the server computer allows the call to proceed, connecting John Doe's communication device to participate in the call.

However, if the device identifier in the call request, or obtained from the device, does not match the stored device identifier, “A1B2C3D4E5”, the server computer will temporarily place the call in a suspended state, while an authentication process is performed. The mismatching identifiers may indicated that John Does is using a new, yet-to-be registered device, or alternatively, that an unauthorized device is attempting to use John Doe's phone number. In the second case, this likely means John's SIM card has been swapped with another device by a malicious actor.

To confirm John's identity, the server computer invokes an authentication process. For example, a message is sent to John via a client communications app that is associated with the communications service, where the message prompts him to take action to authenticate, such as by sending a passcode to a specific phone number via the native messaging application of the device that is using the phone number. This authentication process is further protected by the separate authentication scheme required for accessing the messaging service itself. Unless the legitimate user John Doe logs into the messaging service, he will not receive the authentication prompt message. Only if authentication succeeds will the server computer allow the call to proceed. This verification process ensures calls connected by the server are only routed to subscriber's expected devices, thwarting SIM swapping attacks.

Alternatively, with some embodiments, a mobile device of a subscriber to the communications service will include both a client communications application, capable of placing calls, and a native dialer. In this context, the native dialer is the application on the mobile device to which the subscriber's phone number is registered via a device profile. The client communications application includes functionality similar to the native dialer, and is able to place calls, and also seamlessly hand-off calls, to be handled by the native dialer. In order to verify that the native dialer is operating normally, using the phone number and device that have been registered with the communications service, the dialer of the client communications application will periodically place a “synthetic” call to a dedicated phone number associated with the communications service, as part of periodic verification process. This may occur in the background, for example, when the device is not actively in use by the user.

In this context, a synthetic call is a simulated phone call that is programmatically generated by the dialer of the client communications application for verification purposes. The synthetic call does not connect two parties for an actual conversation. Instead, the client communications application initiates the synthetic call by sending a call request to the server computer of the communications service. This call request may be transmitted via a data connection, such as WiFi or via the mobile data, rather than the traditional mobile network.

After initiating the synthetic call, the client communications application attempts to hand-off the call to the native dialer application. The client communications application essentially requests the mobile operating system to transition the call from itself to the native dialer. If the native dialer application is operating normally, meaning the device's SIM card is intact, this hand-off will succeed. The native dialer will take over the call using the mobile network-provisioned phone number and maintain an active call status. This will be seamlessly detected by the communications service server.

However, if the native dialer application is unable to accept the hand-off, for example due to the device's SIM being swapped, then the call will timeout after a predetermined duration. This failed hand-off indicates the native dialer likely does not have proper mobile network connectivity, suggesting the device's SIM may be compromised. As an additional verification step, the client communications application may temporarily disconnect the device's Wi-Fi connection before attempting the hand-off. If the hand-off still fails with Wi-Fi disabled, it confirms lack of cellular data connectivity and a likely SIM swap. In this manner, the periodic synthetic call hand-off provides an automated way for the client communications application, operating in tandem with a sever of the communications service, to check the integrity of the native dialer and its associated SIM connectivity.

Furthermore, a third hybrid approach combines the on-demand synthetic call procedure with device identifier comparison. In this approach, the server computer only initiates the synthetic call hand-off when a suspicious change in device identifier is detected during call processing. This targeted invocation of the verification procedure aims to balance security, efficiency, and user experience.

Embodiments of the present invention provide technical solutions to technical problems in the field of mobile security and preventing SIM swapping attacks. The first embodiment allows the communications service server to proactively verify a device's identifier when receiving a call request. This thwarts hackers from using stolen SIM credentials and intercepting calls intended for the victim. The second embodiment enables persistent automated testing of the native dialer's SIM connectivity in the background. The synthetic call hand-off technique detects SIM swaps without any visible impact to the user. Together, the two solutions enhance security, deliver seamless protection to subscribers, and prevent unauthorized use of mobile accounts and credentials. The tight integration between the communications service and mobile network operator delivers mutual value, leveraging their respective technical capabilities for more robust SIM swap prevention. The embodiments solve pressing technical challenges in an elegant manner to significantly improve mobile security. Other aspects and advantages of the various embodiments of the invention will be readily apparent to those skilled in the art from the description of the several figures that follows.

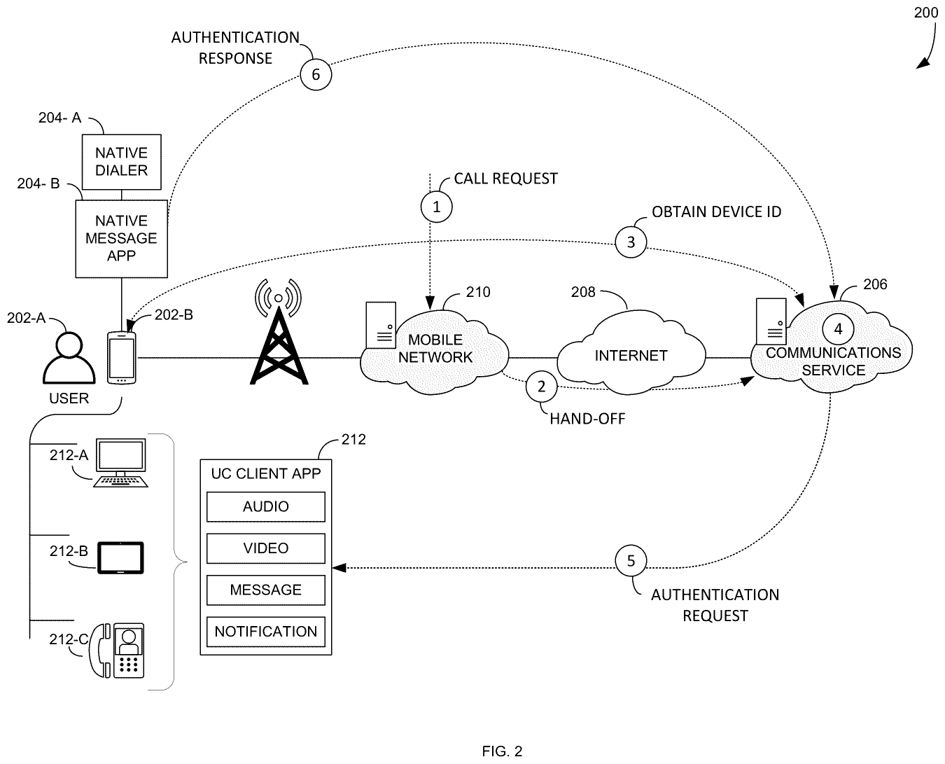

FIG. 2 is a diagram illustrating a network environment 200, consistent with which an embodiment of the invention may be deployed, wherein the network environment 200 includes a unified communications service 206 that has been integrated to operate seamlessly with a mobile network 210. A Mobile Network Operator, or MNO, may partner with a provider of unified communications services, referred to hereafter as simply, a communications service, in order to integrate their respective networks and service offerings. For example, this type of integration allows a subscriber to a mobile network, who also is a subscriber to the communications service, to leverage the robust mobile network 210 while also gaining access to the various communications services 206 of the communications service provider, like messaging, audio/video calling, screen sharing, file sharing, and many others. In many instances, the various communications services of the communications service 206 may be accessible to the subscriber on a variety of client computing devices, such as the mobile computing device 202-B, desktop computer 212-A, tablet computer 212-B. and telephone device 212-C, using a unified communications client application 212.

The integration of the mobile network 210 with the communications service 206 involves the mobile network operator routing phone calls and text messages (e.g., including SMS message) placed to a subscriber's phone number to a server computer of the communications service 206, in addition to their own mobile network routing. Typically, the communications service 206 maintains a database mapping each subscribers' phone number to their respective user accounts. In some cases, the communications service may also maintain a database to track each registered computing device of each user or subscriber. Accordingly, when the communications service 206 receives a phone call or text message for a subscriber, the communications service 206 will check the mapping to identify the correct user account.

The communications service 206 then routes the incoming communication simultaneously to all of the user's registered computing devices, or any computing device via which the user is currently logged in. This includes not only routing over the mobile network 210 to the user's native dialer 204-A, but also routing over the Internet 208 to computing devices with the unified communications (UC) client app 212 installed, such as the computing devices 212-A, 212-B, and 212-C. For example, when a telephone call is placed to the user's mobile phone number, the communications service 206 routes the call to the user's native dialer 204 to ring their mobile phone, while also routing the call over IP (Internet Protocol) to ring the user's desktop and tablet computing devices 212-A and 212-B, where they are logged into the UC client app 212.

This integration allows subscribers to leverage the robustness and ubiquity of the MNO's mobile network, while also gaining the flexibility of the unified communications services that sync communications across devices. Users can seamlessly transition calls between their native dialer 204 and UC client app 212 without interruption. The mobile computing device telephone number serves as a unifying endpoint that rings all of the user's registered communication devices.

As explained in further detail below, another advantage of this integration is the ability to authenticate a user's native dialer 204, to ensure that the user is not a victim of SIM jacking or SIM swapping. The numbers “1” through “6” enclosed in circles as shown in FIG. 2 are intended to represent a set of numbered steps corresponding with the operations and communications that are performed as part of the authentication of a user's native dialer, according to some embodiments.

In the example as presented in FIG. 2, the user 202-A is a subscriber to both a mobile network 210 and a communications service 206. The communications service 206 provides unified communications capabilities such as audio/video calling, messaging, screen sharing, etc. through a UC client application 212 installed on the user's devices. As indicated by the encircled “1” (e.g., step one), a call request is directed to and received at the mobile network 210. This call request may be an outbound call originating at the native dialer 204-A of the user's mobile computing device 202-B. Alternatively, the call request may be an inbound call, originating from another device (not shown) but directed to the phone number of the user's mobile computing device.

In this example, although the call request is received at the mobile network 210, the call request is immediately handed off or transferred to the communications service 206, as indicated by the enclosed “2” (e.g., step 2). This occurs, for example, as a result of the mobile network 210 determining that the telephone number associated with the call request is mapped to a subscriber of the communications service 206.

Upon receiving the call request, the communications service 206 obtains a unique device identifier associated with the user's mobile computing device 202-B. This is indicated in FIG. 2 by the encircled “3” (e.g., step 3). There are various techniques the communications service 206 can use to obtain this unique device identifier. For example, the unique device identifier may be included as a specific data field within the call request message itself, in which case the communications service 206 simply extracts the unique device identifier by parsing the appropriate field. Alternatively, the unique device identifier can be obtained through call signaling protocols like Session Initiation Protocol (SIP). The SIP protocol can be leveraged to send a request, from a server computer of the communications service 206, to the mobile computing device 202-B for its unique device identifier, which the mobile computing device 202-B will then return in the SIP signaling response. Other protocols may also be used to solicit the unique device identifier from the mobile computing device 202-B.

In some instances, the unique device identifier will be a hardware-specific value like the Media Access Control (MAC) address. But in some cases, the unique device identifier could be a different permanent identifier assigned to the device hardware. Once obtained, the communications service 206 compares this current unique device identifier to a previously stored identifier associated with the user's account, as indicated by the enclosed “4” (e.g., step 4). A mismatch between the current and stored identifiers could indicate one of at least two possible scenarios. First, a mismatch may indicate an unauthorized SIM swap to a new device, for example, by a malicious actor. Alternatively, a mismatch could also indicate a legitimate user has simply begun using their SIM in a new mobile computing device, different from the one previously associated with their account, or moved a SIM to an eSIM of the same or a different device. In any case, the mismatch triggers the communications service 212 to initiate an authentication process.

Consistent with some embodiments, the authentication process involves the communications service 206 sending a message that includes an authentication request via a messaging service that is part of the service offering of the communications service 206. This is illustrated in FIG. 2 by the line associated with the encircled “5” (e.g., step 5). The message may be sent to one or more registered computing devices of the user, where the user is currently logged into the messaging service. In some examples, the authentication request is a prompt instructing the user to use the native messaging application (e.g., the application configured to use the telephone number assigned to the user's SIM) to send a specific passcode or string of characters to a designated phone number associated with the communications service. Successful receipt of the passcode authenticates the user.

Alternatively, with some embodiments, the authentication request may include a quick response (QR) code that is communicated to one or more of the user's computing devices via the messaging service. The prompt instructs the user to scan the QR code using the mobile computing device 202-B associated with their account, and derive a passcode from the scanning process. The user must then send this derived passcode via the native messaging application to a phone number associated with the communications service, which upon receipt, authenticates the user. In some cases, the authentication request could alternatively be provided via an audio prompt played back over a voice call through the UC client application 212, or sent as a notification to the UC client app 212, rather than via a text or QR code-based messaging interaction.

In FIG. 2, the authentication response indicated by the dashed line associated with encircled “6” (step 6) is shown as coming from the native messaging application 204-B of the mobile computing device 202-B. The native dialer 204-A and native messaging application 204-B are default system-provided applications included on the mobile operating system (e.g., Android, iOS) of the mobile computing device 202-B. Both applications are configured to use the telephone number assigned to the SIM card 104 as the address for sending and receiving calls and text messages (including SMS message), respectively.

Specifically, the native dialer 204-A allows the user to make and receive phone calls using the SIM's associated telephone number. The native messaging application 204-B enables sending and receiving text messages (including SMS messages) to the SIM's phone number as well. Both system applications are integrated with the mobile network 210 and use the SIM card to identify the device for communications over the mobile network infrastructure. Therefore, any calls or texts made by the native dialer or messaging app will be recognized as coming from the user's SIM telephone number by the mobile network 210 and the communications service 206.

As described in connection with FIG. 2, in some embodiments, the authentication process occurs immediately following the detection of a mismatch in the obtained device identifier (e.g., step 3) and the stored device identifier, such that the original call request is held in a pending or intermediate state, and not fully processed until after the user successfully authenticates (e.g., within a predetermined period of time such as 2 minutes). However, in alternative embodiments, the call request may be fully processed to connect the telephone call, while the authentication process occurs in parallel, or shortly after connecting the call. In these cases, the authentication may be required within a certain window of time following the call being connected, such as within the next 30 minutes, within 4 hours, within 24 hours, and so forth. By allowing the call connection while performing authentication in parallel, this alternative approach prioritizes call completion and continuity, while still ensuring the user authenticates within a reasonable duration following call connection to validate they are in authorized possession of the device associated with their subscriber account and telephone number.

As set forth above in connection with the description of FIG. 2, one example of a unique device identifier that may be used, consistent with some embodiments, is a MAC address. Those skilled in the art will recognize that a variety of other identifiers could be used as the unique device identifier, including any one or more of the following, or various combinations of the following:
IMEI (International Mobile Equipment Identity)—A 15-17 digit code that uniquely identifies a mobile device. It is assigned to the device hardware itself, not the SIM card.
MEID (Mobile Equipment Identifier)—A 56-bit identifier assigned to CDMA mobile devices. It identifies the physical device rather than the subscriber.
UUID (Universally Unique Identifier)—A standardized 128-bit number that gets generated and assigned to a device by its operating system. It is unique across all device hardware and software.
UDID (Unique Device Identifier)—A sequence of 40 letters and numbers specific to an iOS device. It gets associated with the hardware components.
Serial Number—A unique serial number embedded into a device's hardware by the manufacturer to identify the specific device unit.
Wi-Fi MAC Address—Separate from the network interface MAC address, this identifies the device's Wi-Fi radio hardware.
Bluetooth MAC Address—Identifies a device's Bluetooth radio and is unique across all Bluetooth devices.
CPU ID—Identifiers like CPU serial number or chipset model number can also be used to identify hardware components in a device.

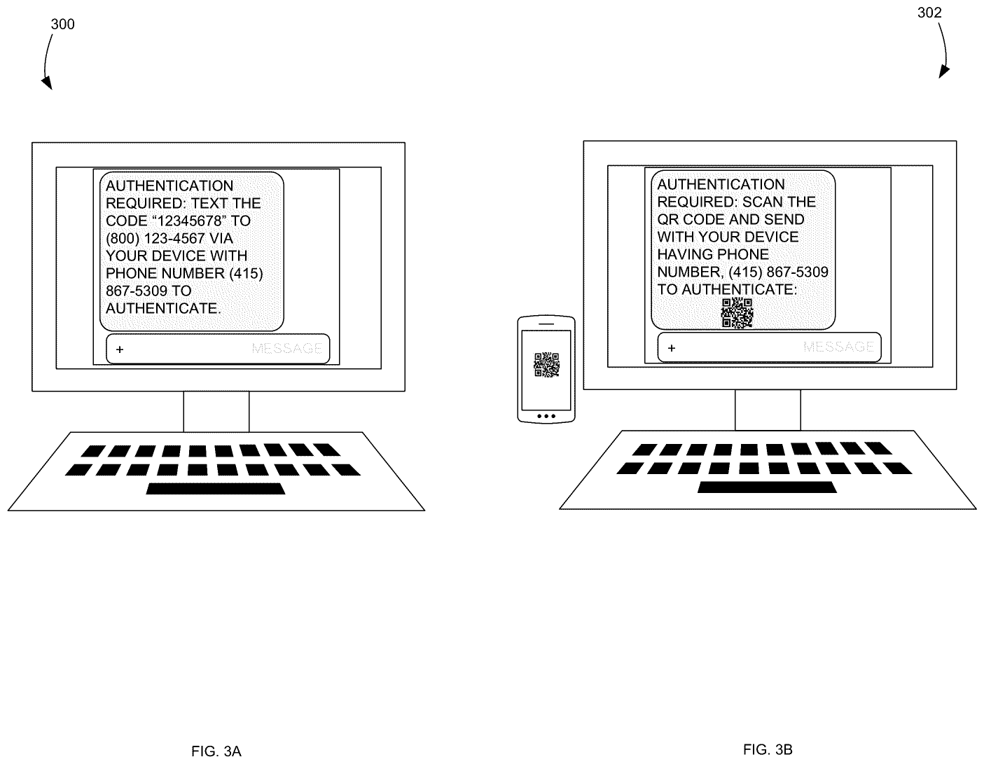

FIG. 3A illustrates a user interface 300 of a messaging application associated with the communications service, consistent with some embodiments, where the authentication request involves a message to the user containing a prompt to text a specific passcode using the native messaging application of the mobile computing device. In this example, the user has the UC client application installed on a computing device such as a desktop computer 302. The UC client application provides access to the various unified communication services offered by the provider, including messaging. The user is logged into the messaging service via the UC client application.

When the communications service detects the mismatch in device identifiers that warrants authentication, a message is communicated to the UC client application of the user. This message contains instructions prompting the user to text a specific passcode (e.g. “12345678”) to a designated phone number (e.g. “800-123-4567”) using the native messaging application of the mobile computing device associated with their subscriber account and SIM.

The native messaging application is the default text messaging application provided by the mobile operating system, and is configured to send texts using the phone number assigned to the SIM card in the device. By requiring the passcode be sent via the native messaging app, this ensures that the device transmitting the code has proper connectivity through the mobile network using the expected SIM card associated with the user's account. Once the user follows the instructions and sends the passcode text from the telephone number associated with the SIM to the specified number, the communications service receives the passcode Because the passcode is received from the telephone number of the SIM, this indicates that the user has access to the expected SIM card and has mobile network connectivity through the SIM. Upon validating the received code, the communications service can authenticate the user. At this point, the pending call request can proceed given the identity of the device and subscriber account has been verified through the messaging-based authentication process.

After authenticating the user via the messaging-based passcode process, a follow-up message may be communicated to the user asking the user to confirm that the SIM is now knowingly associated with a new device. This follow-up message prompts the user to verify whether they have recently switched devices or obtained a new SIM card tied to their subscriber account. If the user provides confirmation, indicating their awareness of the device change, the communications service can update its internal user data records to reflect the new unique device identifier (e.g. MAC address) that is now associated with the user's SIM and account. This allows the communications service to keep accurate device profiles for each user in its system for future authentication needs. However, if the user indicates they did not authorize or expect a SIM card or device change, the service may take additional fraud prevention measures such as temporarily suspending the account, reverting to the old device identifier profile, or requiring further in-person verification.

FIG. 3B illustrates a user interface 302 of a messaging application associated with the communications service, consistent with some embodiments, where the authentication request involves a message to the user containing a prompt to scan a QR code. In this example, the user is logged into the messaging service of the communications provider via a UC client application on a desktop computer. When the communications service detects a mismatch in device identifiers, a message containing a unique QR code is transmitted to the desktop application.

The message prompts the user to scan the QR code using the mobile computing device associated with their subscriber account and SIM card. When the user scans the QR code using a camera application on their mobile computing device, the camera application decodes the QR code and displays a unique passcode. The user is prompted to send this decoded passcode via the native messaging application on their mobile computing device to a specified phone number associated with the communications service.

Similar to the previous example described in connection with FIG. 3A, sending the decoded passcode from the native messaging application proves that the mobile device has proper mobile network connectivity through the expected SIM associated with the user's account. Once the communications service receives the passcode, it authenticates the user and proceeds with processing the pending call request. Additionally, after authenticating the user, the communications service updates its database of subscriber accounts to record the new device identifier associated with the user's SIM and account. This allows the service to keep accurate device profiles for each user for future authentication needs. In summary, the QR code authentication approach leverages the native scanning and messaging capabilities of the user's mobile device to verify their identity and authorized use of the SIM associated with their subscriber account.

If the user is unable to complete the authentication process by providing the valid passcode via the native messaging application, this indicates the user's SIM card may be compromised. In this event, the communications service can take measures to secure the user's account and prevent fraudulent activity. For example, the service may temporarily suspend the ability for the user's telephone number and associated SIM card to send or receive calls and text messages over the mobile network. The mobile network operator can be notified that the SIM card may be compromised. The user can also be notified through the UC client application about the failed authentication attempt, along with information to contact customer support, such as a link to a help page or a dedicated phone number to call. Other reasonable actions to secure the user's account and the compromised SIM card may also be performed, such as requiring in-person verification, reverting to an old device identifier profile if available, prompting the user to obtain a new SIM card from the mobile operator, forcing a password reset before the account can be used again, or suggesting the user contact law enforcement.

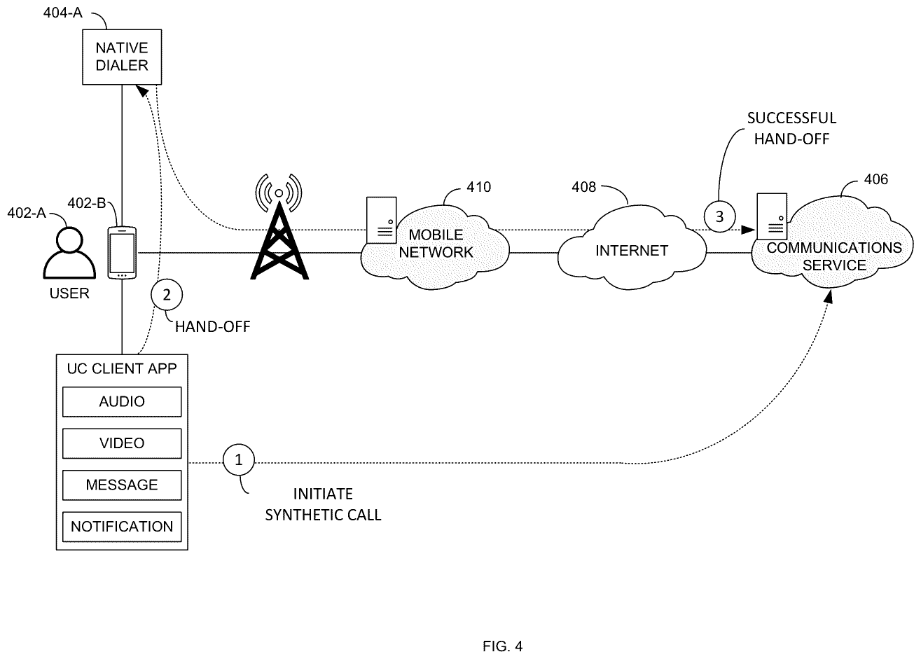

FIG. 4 illustrates an alternative technique for authenticating a mobile computing device, and specifically, the native dialing application of the device. In this technique, the mobile device includes a native dialer, and a UC client application. The UC client application is configured to periodically place a synthetic call to the communications service. A synthetic call is a simulated phone call that is generated programmatically by the UC client application for verification purposes. It does not connect two parties for an actual conversation.

The authentication process works as follows. The UC client application on the mobile device initiates a synthetic call, as indicated by the encircled “1” (e.g., step one). This synthetic call may be a VoIP call that uses Internet data rather than the cellular network. The synthetic call is received and acknowledged by the communications service. After initiating the synthetic call, the UC client application attempts to hand-off the call to the native dialer application, as indicated by the dashed line associated with encircled “2” (e.g., step two). The UC client application essentially requests the mobile operating system to transition the call from the UC client application to the native dialer application.

If the native dialer application is operating normally, meaning the device's SIM card is intact, this hand-off will succeed. The native dialer will take over the call using the MNO-provisioned mobile number and maintain an active call status. This will be seamlessly detected by the communications service. However, if the native dialer application is unable to accept the hand-off, for example due to the device's SIM being swapped, then the call will timeout after a predetermined duration. This failed hand-off indicates the native dialer likely does not have proper mobile network connectivity, suggesting the device's SIM may be compromised. In this manner, the periodic synthetic call hand-off provides an automated way for the UC client application to check the integrity of the native dialer application and its associated SIM connectivity.

In some embodiments, the native dialing application on the mobile device may be configured to use Wi-Fi calling. This means it can route calls through a Wi-Fi data connection when cellular network connectivity is limited. However, to effectively test the integrity of the native dialer's SIM connectivity, the authentication process needs to force the use of the cellular or mobile network. To address this, consistent with some embodiments, when the UC client application initiates the periodic synthetic call, it communicates with the mobile operating system to temporarily disable the device's Wi-Fi connection. For example, the UC client app may invoke an API call to turn off the Wi-Fi radio for a short duration of 5-10 seconds.

During this brief Wi-Fi disconnection, the UC client app hands the synthetic call over to the native dialer. With Wi-Fi disabled, the native dialer must use the cellular network and SIM to maintain the call. If the hand-off fails within the short window of Wi-Fi downtime, it indicates the native dialer likely has no cellular connectivity or SIM access, suggesting a potential security compromise.

A third embodiment provides an enhanced authentication process by integrating operations from the first two embodiments. In this third approach, the communications service leverages synthetic calling to verify the native dialer application, but only initiates the synthetic call procedure after detecting a potential unauthorized device change—for example, a device identifier mismatch.

For example, during the processing of an inbound or outbound call, the communications service will obtain the unique device identifier and compare it to the stored identifier, as described in the first embodiment. If a mismatch is detected, indicating an abnormal or suspicious change, the server will trigger the synthetic call procedure to authenticate the device.

In this third embodiment, the synthetic call hand-off from the UC client application to the native dialer does not occur on a fixed schedule. Rather, the communications service sends a command to the UC client application on the mobile device, instructing it to initiate the synthetic call authentication. This on-demand synthetic call allows more efficient and targeted validation of the native dialer's integrity.

If the synthetic call hand-off fails within the allotted time, the communications service determines the device is likely compromised. Appropriate notifications, account suspensions, or other security measures can then be enacted.

By combining the on-demand synthetic calling procedure with the identifier comparison, this hybrid approach allows for authentication specifically when suspicious activity is detected. It aims to balance security, efficiency, and user experience. The synthetic call hand-off provides a robust validation of the native dialer's connectivity while minimizing unnecessary signaling overhead when no abnormal device changes occur.'

While the descriptions of the embodiments in FIG. 2 and FIG. 4 present the mobile network and communications service as separate entities, in some alternative embodiments, the functionality could be provided by a single provider as part of an integrated service offering. For example, a mobile carrier could offer its own proprietary unified communications service, including features such as messaging, audio/video calling, and file sharing. This integrated mobile carrier could perform the functions attributed to both the mobile network and separate communications service in the above embodiments. Specifically, an integrated mobile carrier could detect device identifier mismatches on their network, initiate synthetic call hand-offs, and authenticate users-all within their own infrastructure and platforms. Such a consolidated model would aim to provide users with seamless mobile communication and robust security measures through a single mobile service provider, without reliance on a third-party communications service.

### Machine and Software Architecture

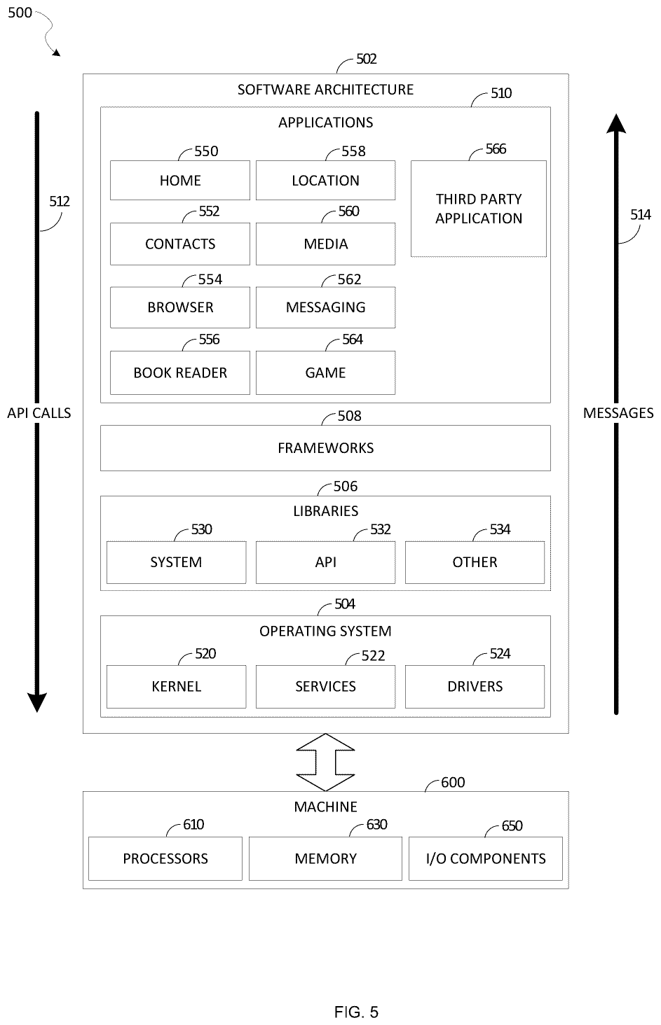

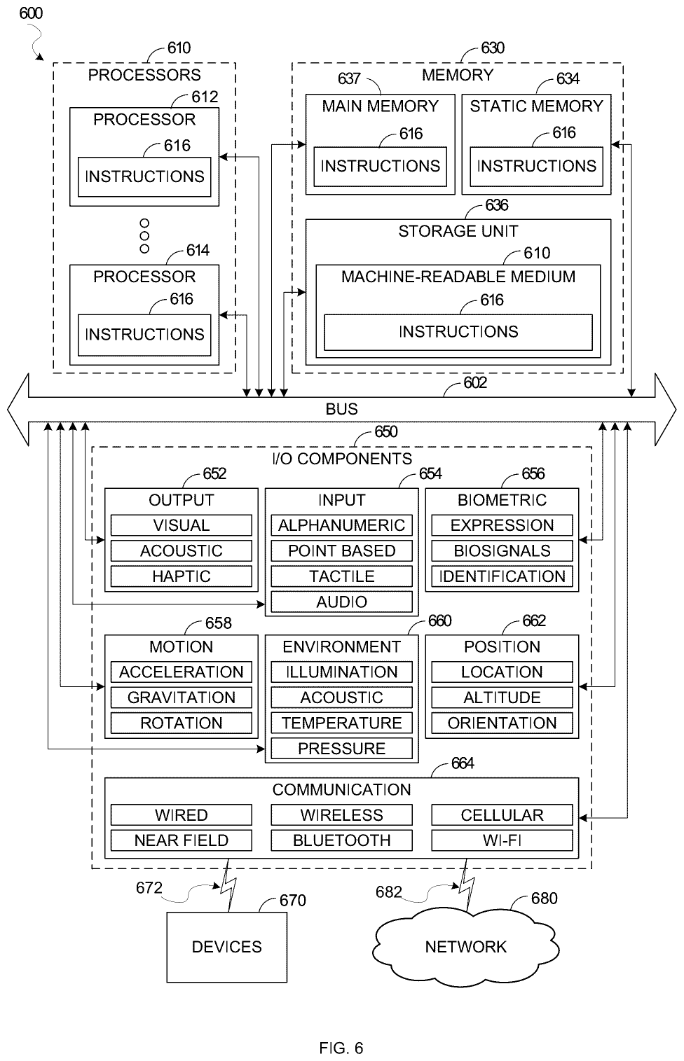

FIG. 5 is a block diagram 500 illustrating a software architecture 502, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 602 includes layers such as an operating system 504, libraries 506, frameworks 508, and applications 510. Operationally, the applications 510 invoke API calls 512 through the software stack and receive messages 514 in response to the API calls 512, consistent with some embodiments.

In various embodiments, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers). Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4). Advanced Video Coding (H.264 or AVC). Moving Picture Experts Group Layer-3 (MP3). Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 634 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute any one of the methods or algorithmic techniques described herein. Additionally, or alternatively, the instructions 616 may implement any one of the systems described herein. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 916 to perform any one or more of the methodologies discussed herein.

The machine 600 may include processors 610, memory 630, and I/O) components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, all accessible to the processors 610 such as via the bus 602. The main memory 630, the static memory 634, and storage unit 636 store the instructions 616 embodying any one or more of the methodologies or functions described herein. The instructions 916 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417. Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or storage unit 636 may store one or more sets of instructions and data structures (e.g., software) embodying or utilized by any one or more of the methodologies or functions described herein. These instructions (e.g., the instructions 616), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks, magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for detecting a Subscriber Identity Module (SIM) swap at a mobile computing device configured to place and receive telephone calls via a native dialer application using a telephone number assigned to the SIM, the method comprising:
at a server computer of a communications service, receiving from the mobile computing device a request to initiate a telephone call;
obtaining a first value of a first identifier uniquely identifying the mobile computing device, and a second value for a second identifier uniquely identifying a subscriber to the communications service;
comparing the first value of the first identifier with a stored value of the first identifier; and
upon determining a difference between the value of the first identifier and the stored value of the first identifier, holding the request to initiate the telephone call in a pending state while invoking an authentication process to authenticate the subscriber before further processing the request to initiate the telephone call.

2. The method of claim 1, wherein invoking the authentication process comprises:
sending a message including a passcode from a server computer of the communications service to a client messaging application via which the subscriber is currently logged in to a messaging service of the communications service;
prompting a user of the computing device via the message to send a text message that includes the passcode to a particular telephone number using a native messaging application executing on the mobile computing device; and
receiving, at a server computer of the communications service, the text message sent by the native messaging application, wherein successful receipt of the text message with the passcode authenticates the subscriber.

3. The method of claim 2, wherein the native messaging application is configured to send and receive text messages using the telephone number assigned to the SIM.

4. The method of claim 1, wherein invoking the authentication process comprises:
communicating a quick response (QR) code to a user of the mobile computing device via a client messaging application associated with a messaging service of the communications service executing on the computing device:
prompting the user via the client messaging application to scan the QR code using an image sensor of the mobile computing device, and to send a text message including a passcode derived via the scanning of the QR code to a particular telephone number;
wherein successful receipt of the text message with the derived code authenticates the subscriber.

5. The method of claim 1, wherein the second value of the second identifier is the telephone number of the subscriber, and wherein the server computer stores a data record that associates the stored value of the first identifier with the telephone number of the subscriber.

6. The method of claim 1, wherein the first identifier is a media access control (MAC) address of the mobile computing device, and obtaining the first value of the first identifier comprises:
extracting the MAC address from a session initiation protocol (SIP) signal received at the server computer in association with the request to initiate the telephone call.

7. The method of claim 1, wherein obtaining the device identifier comprises:
sending, from the server computer to the mobile computing device, a request to provide the device identifier; and
receiving a response at the server computer from the mobile computing device, the response including the device identifier.

8. A system for detecting a Subscriber Identity Module (SIM) swap at a mobile computing device configured to place and receive telephone calls via a native dialer application using a telephone number assigned to the SIM, the system comprising:
one or more processors;
a memory storing instructions that, when executed by the one or more processors, cause the system to:
receive, from the mobile computing device, a request to initiate a telephone call;
obtain a first value of a first identifier uniquely identifying the mobile computing device, and a second value for a second identifier uniquely identifying a subscriber to a communications service;
compare the first value of the first identifier with a stored value of the first identifier; and
upon determining a difference between the value of the first identifier and the stored value of the first identifier, hold the request to initiate the telephone call in a pending state while invoking an authentication process to authenticate the subscriber before further processing the request to initiate the telephone call.

9. The system of claim 8, wherein invoking the authentication process comprises:
sending a message including a passcode to a client messaging application via which the subscriber is currently logged in to a messaging service;
prompting a user of the computing device via the message to send a text message that includes the passcode to a particular telephone number using a native messaging application executing on the mobile computing device; and
receiving the text message sent by the native messaging application, wherein successful receipt of the text message with the passcode authenticates the subscriber.

10. The system of claim 9, wherein the native messaging application is configured to send and receive text messages using the telephone number assigned to the SIM.

11. The system of claim 8, wherein invoking the authentication process comprises:
communicating a quick response (QR) code to a user of the mobile computing device via a client messaging application associated with a messaging service executing on the computing device;
prompting the user via the client messaging application to scan the QR code using an image sensor of the mobile computing device, and to send a text message including a passcode derived via the scanning of the QR code to a particular telephone number;
wherein successful receipt of the text message with the derived code authenticates the subscriber.

12. The system of claim 8, wherein the second value of the second identifier is the telephone number of the subscriber, and wherein the system stores a data record that associates the stored value of the first identifier with the telephone number of the subscriber.

13. The system of claim 8, wherein the first identifier is a media access control (MAC) address of the mobile computing device, and obtaining the first value of the first identifier comprises:
extracting the MAC address from a session initiation protocol (SIP) signal received in association with the request to initiate the telephone call.

14. The system of claim 8, wherein obtaining the device identifier comprises:
sending a request to the mobile computing device to provide the device identifier; and
receiving a response from the mobile computing device, the response including the device identifier.

15. A non-transitory computer-readable medium storing instructions that, when executed by one or more processors, cause the one or more processors to perform steps for detecting a Subscriber Identity Module (SIM) swap at a mobile computing device configured to place and receive telephone calls via a native dialer application using a telephone number assigned to the SIM, the steps comprising:
receiving, from the mobile computing device, a request to initiate a telephone call;
obtaining a first value of a first identifier uniquely identifying the mobile computing device, and a second value for a second identifier uniquely identifying a subscriber to a communications service;
comparing the first value of the first identifier with a stored value of the first identifier; and
upon determining a difference between the value of the first identifier and the stored value of the first identifier, holding the request to initiate the telephone call in a pending state while invoking an authentication process to authenticate the subscriber before further processing the request to initiate the telephone call.

16. The non-transitory computer-readable medium of claim 15, wherein invoking the authentication process comprises:
sending a message including a passcode to a client messaging application via which the subscriber is currently logged in to a messaging service;
prompting a user of the computing device via the message to send a text message that includes the passcode to a particular telephone number using a native messaging application executing on the mobile computing device; and
receiving the text message sent by the native messaging application, wherein successful receipt of the text message with the passcode authenticates the subscriber.

17. The non-transitory computer-readable medium of claim 15, wherein the second value of the second identifier is the telephone number of the subscriber, and wherein the instructions cause the one or more processors to store a data record that associates the stored value of the first identifier with the telephone number of the subscriber.

18. The non-transitory computer-readable medium of claim 15, wherein the first identifier is a media access control (MAC) address of the mobile computing device, and obtaining the first value of the first identifier comprises:
extracting the MAC address from a session initiation protocol (SIP) signal received in association with the request to initiate the telephone call.

19. The non-transitory computer-readable medium of claim 15, wherein obtaining the device identifier comprises:
sending a request to the mobile computing device to provide the device identifier; and
receiving a response from the mobile computing device, the response including the device identifier.

20. The non-transitory computer-readable medium of claim 15, wherein the steps further comprise:
upon successful authentication of the subscriber, updating a database to associate the obtained first value of the first identifier with the second value of the second identifier.
